(19) United States
(12) Patent Application Publication
(10) Pub. No.: US 2010/0241556 A1
(43) Pub. Date: Sep. 23, 2010

(54) SYSTEM AND METHODOLOGY FOR MANAGING COMPLIANCE OF MORTGAGE LOANS TO HOMEOWNERS

(75) Inventors: Thomas H. Reinheimer, Jacksonville, FL (US); Nathan Groff, Jacksonville, FL (US); David Berry, Jacksonville, FL (US)

Correspondence Address: ROGERS TOWERS, P.A., 1301 RIVERPLACE BOULEVARD, SUITE 1500, JACKSONVILLE, FL, 32207, US

(73) Assignee: Veritec Solutions, LLC, Jacksonville, FL (US)

(21) Appl. No.: 12/355,850

(22) Filed: Jan. 19, 2009

Related U.S. Application Data
(63) Continuation-in-part of application No. 11/941,972, filed on Nov. 19, 2007.
Application No. 11/941,972 is a continuation-in-part of application No. 12/180,559, filed on Jul. 27, 2008.

(51) Int. Cl. G06Q 40/00

(52) U.S. Cl. 705/38; 705/35

(57) ABSTRACT

A computer-implemented system and method for mortgage lending management and compliance receives, from a user, lending transaction data for a loan, property and a borrower; automatically determines if the loan complies with legal requirements and/or requires counseling based on the presence of one or more triggers (i.e., indicia of subprime or predatory lending) in the data, and notifying parties of the determination; and receives, from a counselor, counseling data for the loan and borrower. After any necessary counseling has been obtained and the counselor supplies all needed data, a certificate may be generated evidencing a counseling determination. The certificate may be transmitted to an office of a recorder for a jurisdiction in which the property is located. Suspicious activity may be flagged for appropriate investigation and remedial action by an administrator. Further progress may be halted until the administrator provides responsive input.

### RELATED APPLICATION

This application is a continuation in part and claims the benefit of priority of pending U.S. nonprovisional application Ser. No. 11/941,972, filed Nov. 19, 2007, the entire contents of which are incorporated herein by this reference; and a continuation in part of pending U.S. nonprovisional application Ser. No. 12/180,559, filed Jul. 27, 2008, the entire contents of which are incorporated herein by this reference.

### FIELD OF THE INVENTION

This invention generally relates to mortgage lending transactions, and more particularly, to an automated system and method for managing lending transactions, requiring participants to input information into the system for regulatory review and determining whether a lending transaction complies with then-current applicable laws and regulations, such as laws and regulations requiring borrowers to attend credit counseling as a condition precedent for a loan transaction.

### BACKGROUND

Mortgage financing and refinancing, including subprime mortgage lending, has grown substantially in recent years. Proponents contend that by extending credit to borrowers with blemished credit, subprime loans can enhance welfare. However, concerns about lending abuses and predatory lending have increased dramatically with the rise in subprime lending. Allegations of predatory lending practices abound, with some unscrupulous lenders deliberately targeting borrowers who may not have fully understood the terms of their loan, or lending to people who were never likely to afford the interest payments in the long-run. Many subprime loans include exorbitant fees and hidden terms and conditions, and frequently led to default, seizure of collateral, and foreclosure. To stem the tide of abusive practices, in recent years the states and the federal government have enacted laws to address subprime loan abuses.

As used herein, a subprime loan refers to any non-conforming loan, i.e., any loan that does not meet Fannie Mae, Freddie Mac, Federal or state legal requirements or guidelines. By way of example and not limitation, the size of a loan, income to mortgage payment ratio or the quality of the documentation provided with a loan may render a loan subprime.

In 1994, Congress enacted the first modern, comprehensive anti-predatory lending statute, the Home Ownership and Equity Protection Act (HOEPA). HOEPA addresses certain deceptive and unfair practices in home equity lending. It establishes requirements for certain loans with high rates and/or high fees. If a loan is covered by HOEPA, the borrower must receive several disclosures at least three business days before the loan is finalized. Prohibited practices include, but are not limited to, certain balloon payments; negative amortization, which involves smaller monthly payments that do not fully pay off the loan and that cause an increase in the total principal debt; default interest rates higher than pre-default rates; rebates of interest upon default calculated by any method less favorable than an actuarial method; a repayment schedule that consolidates more than two periodic payments that are to be paid in advance from the proceeds of the loan; most prepayment penalties, including refunds of unearned interest calculated by any method less favorable than the actuarial method.

After HOEPA, some states began enacting anti-predatory lending laws. The state laws vary widely, with some states imposing scant restrictions on covered loans while others imposing heavier ones. Enforcement provisions also vary considerably. Some states provide for government enforcement, while others afford injured borrowers the right to sue. Some laws authorize assignee liability, while others restrict private lawsuits to loan originators and assignees that do not qualify as holders-in-due course. Some laws authorize double or treble damages; others cap monetary relief in private lawsuits at compensatory damages only. Some states take a proactive approach, requiring the borrower to attend a counseling session prior to receiving certain high-risk loans.

While such laws may help curb predatory lending practices, enforcement is problematic. Heretofore, no tools enable monitoring and reviewing loans in a jurisdiction. Thus, regulators could not definitively state how many loans have been made or even how many subprime loans have been made to residents in an area, or how many loans or subprime loans a lender made, or how many loans or subprime loans have resulted in foreclosure. Without such information, regulators cannot identify potential lending abuses, proactively review lending practices and implement consumer protections, or estimate taxes. Furthermore, no tools exist to identify and flag errant lenders and illicit lending practices. What is needed is a system that requires input from lending parties, flags transactions with indicia of fraud or involving errant participants and illicit practices, and enables generation of a wide range of reports.

The invention is directed to overcoming one or more of the problems and solving one or more of the needs as set forth above.

### SUMMARY OF THE INVENTION

To overcome one or more of the problems and solve one or more of the needs as set forth above, a computer-implemented system and method for mortgage lending management and compliance are provided. According to principles of the invention, an exemplary implementation of the method includes steps of creating a user account for each of a plurality of users; receiving, from each user, lending transaction data for a loan, property and a borrower; automatically determining if the loan, as defined by the lending transaction data, is a subprime loan, includes indicia of fraud or requires additional action, such as counseling; if the loan as defined by the lending transaction data includes indicia of fraud, notifying a regulator; if the loan as defined by the lending transaction data requires counseling, transmitting a notice to the borrower indicating that counseling is required; and, in such case, receiving, from a counselor, counseling data for the loan and borrower. Included in another aspect of an exemplary embodiment, a threshold determination may be made to decide if a loan, as defined by some lending transaction data (e.g., loan, property or borrower information), is exempt from certain legal requirements, such as counseling requirements. A certificate may be generated evidencing compliance with reporting requirements and any other requirements such as counseling. The counseling determination may be that counseling was required and provided or that counseling was not required. The certificate may be transmitted to an office of a recorder for a jurisdiction in which the property is located.

Lending transaction and counseling data are requested for user input, received, stored and utilized. The lending transaction data includes information pertaining to the borrower, property, loan, broker, loan originator. The counseling data includes a counselor conclusion, which may be one or more of the following: the loan should be approved; the counselor found indicia of fraud; the borrower cannot afford the loan; the borrower does not understand the transaction; the borrower does not understand the costs associated with the transaction; the borrower's monthly income and expenses have been reviewed and disclosed; the rate of the loan is above market rate; the borrower should seek a competitive bid from another source; there are discrepancies between the borrower's verbal understanding of the loan and the lending transaction data; the borrower is close to not being able to afford the loan; the borrower understands the true cost of debt consolidation and need for credit card discipline; and/or the information that the borrower provided the user has been amended by the user.

Determining if the loan, as defined by the lending transaction data, is subprime and/or requires counseling entails determining if the loan includes at least one trigger. Triggers may include the borrower having a credit score below a determined level; the borrower having a debt-to-income ratio greater than a determined amount; a combined loan-to-value ratio greater than a determined amount; a loan amount exceeding an established conforming loan limit; and/or omission of documentation from the borrower to support stated income and assets of the borrower.

If lending transaction data for the loan or the borrower has changed after a counseling determination has been completed, in which counseling is found to be required or not, then the changed data will be subject to another counseling determination, in which counseling may be required or not. If lending transaction data for the loan or the borrower has changed after counseling has been provided, then the changed data will be subject to another counseling determination, in which counseling (i.e., recounseling) may be required or not.

Suspicious and/or fraudulent activity may be flagged before a certificate is generated. Once flagged, the activity may be reported to an administrator for appropriate investigation and remedial action. Further progress may be halted until the notified party provides responsive input.

An exemplary computer-implemented system for subprime mortgage lending management and compliance is also provided. The system comprises a networked computer system. A database is functionally coupled to a database management system. A user interface is functionally coupled to the database management system. A plurality of modules is operably coupled to the database management system and the user interface. The modules include an account module configured to create a user account and manage user access. A lending transaction module is configured to receive lending transaction data for a transaction by the user, the lending transaction data being entered through the user interface and organized and stored in the database by the database management system. An analysis module is configured to analyze the lending transaction data and determine whether the loan is subprime and/or if counseling is required. A counseling module is configured to receive counselor data and determine if required counseling for the transaction has been provided. The modules may further include a certificate module configured to generate a certificate of compliance; a recounseling module configured to determine if the lending transaction data has changed after counseling and if recounseling is necessary based upon the changed lending transaction data; a reporting module configured to generate user selectable reports includes data from the database; a flag module configured to generate alerts in response to determined lending transaction data and counselor data and a foreclosure module configured to associate foreclosure data with lending transaction data. To determine whether counseling may be necessary as a prerequisite to obtaining a certificate, the analysis module may determine if the lending transaction data includes at least one trigger, as described above. The counselor data may include a conclusion, as described above.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high level block diagram of networked hardware components of an exemplary lending management and compliance system according to principles of the invention; and

FIG. 2 provides a high level flowchart of steps of an exemplary lending management and compliance process according to principles of the invention; and

FIG. 3 provides a high level block diagram of software components of an exemplary lending management and compliance system according to principles of the invention;

FIG. 4 provides a view of a portion of an exemplary tabular report generated using an exemplary lending management and compliance system according to principles of the invention;

FIG. 5 provides a view of a portion of another exemplary tabular report generated using an exemplary lending management and compliance system according to principles of the invention;

FIG. 6 provides a view of a portion of another exemplary tabular report generated using an exemplary lending management and compliance system according to principles of the invention;

FIG. 7 provides a view of a portion of another exemplary tabular report generated using an exemplary lending management and compliance system according to principles of the invention.

Those skilled in the art will appreciate that the Figures are not intended to illustrate every implementation of the invention. Specifically, the invention is not limited to the exemplary implementations, system, components, processes, steps or order of steps depicted in the Figures.

### DETAILED DESCRIPTION

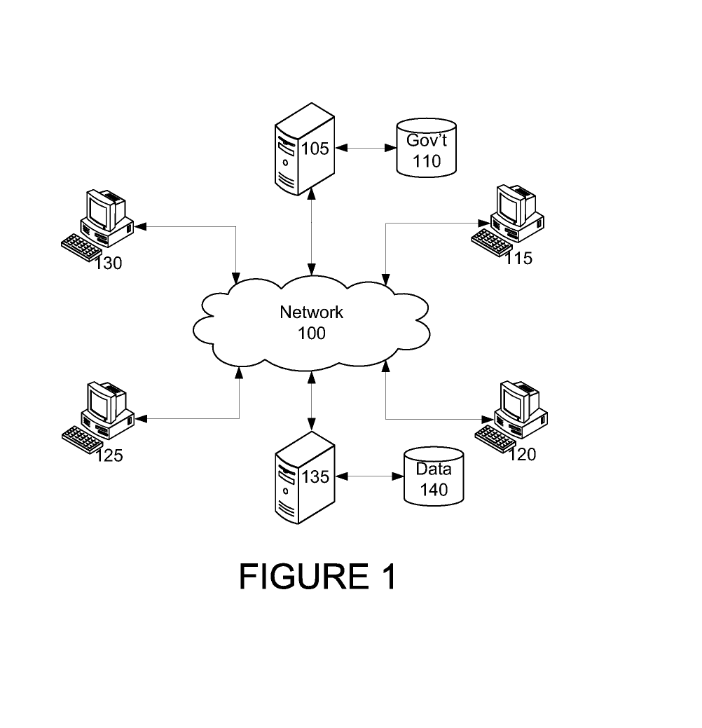

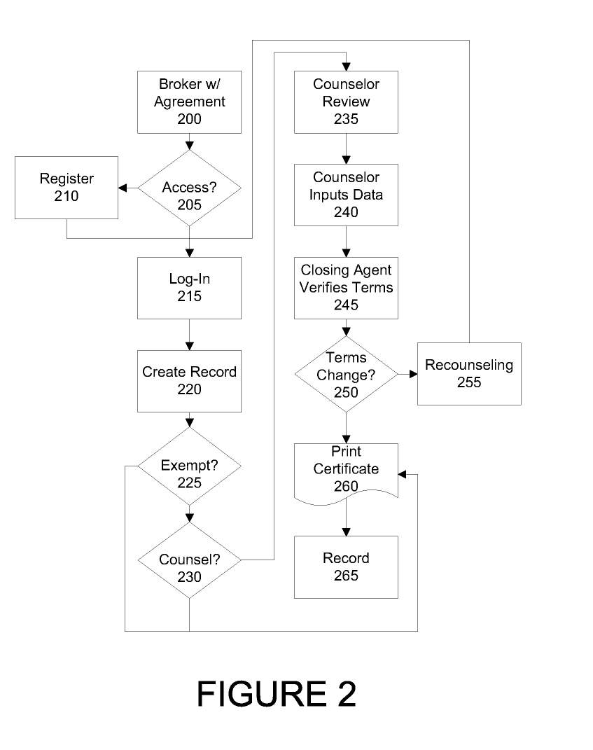

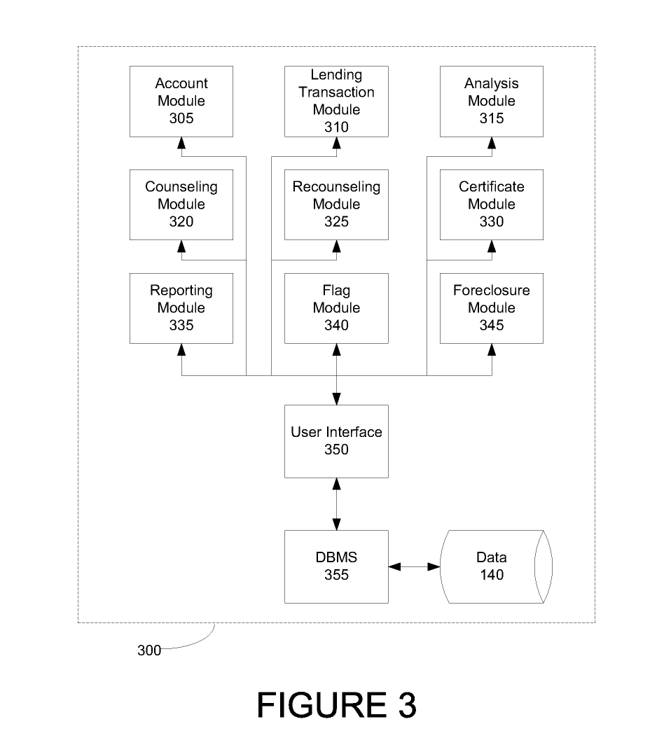

In an exemplary implementation of the invention, an automated system and method for monitoring lending transactions and confirming compliance with then-current applicable laws and regulations, before obtaining a loan, are provided. By way of example and not limitation, such laws and regulations may pertain to subprime lending. Illustratively, such laws may require a borrower to receive counseling, and/or receive a good faith estimate (as required by the Real Estate Settlement Procedures Act), and/or require certain disclosures, limit loans that have rates and fees above specified amounts and prohibit specific acts and practices in connection with mortgage transactions (as provided in The Truth in Lending Act). FIG. 1 provides a high level block diagram of networked hardware components of an exemplary lending management and compliance system according to principles of the invention. FIG. 2 provides a high-level flowchart of an exemplary lending management and compliance methodology according to principles of the invention. FIG. 3 provides a high level block diagram of software components of an exemplary lending management and compliance system according to principles of the invention.

Referring first to FIG. 1, a high level block diagram of components of an exemplary lending management and compliance system according to principles of the invention is shown. One or more governing bodies, such as a legislative and executive branch, regulatory agency and/or court establishes, by enactment, promulgation, ruling or otherwise, laws that govern lending transactions and lenders. The laws establish requirements for lawful lending, including prohibited transactions, requirements for lawful transactions, whether and under what conditions tasks such as counseling must be completed as a prerequisite for a subprime loan. These rules of law define parameters in a computer system configured to manage lending transaction compliance. The computer system comprises one or more computers 135 and associated data storage devices 140 that manage the process. In this particular implementation, the computer system 135 is configured to receive input concerning a lending transaction and determine whether a transaction requires counseling and whether any requisite counseling has been obtained by a borrower in compliance with the requirement. However, this invention is not limited to implementations that determine if a lending transaction is subprime and/or if counseling may be required. Rather, systems that manage lending transaction data and/or monitor compliance with other lending rules, regulations and guidelines is intended to come within the scope of the invention. The one or more computers 135 are preferably accessible over a communications network 100, such as, but not limited to, the Internet.

The exemplary server 135 is comprised of one or more computer systems, each having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, or PCMCIA RAM) and/or other storage equipment. An input device such as a keyboard, touch sensitive screen, a pointing device (e.g., a computer mouse, touch pad or joystick) and the like may also be provided. Software such as network operating system software may be stored on and executable on the server. These elements are typically included in many computer servers. Indeed, the aforementioned server is intended to represent a broad category of computer systems capable of functioning as a computer server and hosting application software for network access and use and database management in accordance with the present invention. Of course, the server 135 may include fewer, different and/or additional elements, functioning as single servers or as a distributed system, provided it is capable of performing functions in accordance with the present invention.

The server 135 hosts (i.e., provides clients with access to) information, documents and software needed to provide functionality and enable performance of methodologies in accordance with an exemplary embodiment of the invention. For example, the server 135 may include web page information and documents (e.g., scripts, HTML and XML code), applets and application software, which manages subscriber access and use, processes transactions and manage databases for subscriber data.

The server 135 may be responsible for accepting HTTP requests from client Web browsers, and serving the requester HTTP responses along with optional data contents, which usually are Web pages such as HTML documents and linked objects (images, etc.). The HTTP response typically consists of an HTML document, but can also be a raw text file, an image, or some other type of script, document, applet, file, message or information. The server may have the capability of logging detailed information, about client requests and server responses, to log files, allowing the Webmaster to collect statistics by running log analyzers on log files. Such statistics may be used for security monitoring and to optimize performance.

One or more database servers may be provided to run a database management system (DBMS) which provides functionality, namely, managing and querying the database(s) 140. The database(s) 140 may be separate or integrated data stores, i.e., structured collections of records or data stored in a computer so that the database management system can consult it to answer queries.

Users (e.g., regulators, brokers, lenders, counselors and closing agents) directly or indirectly access the server 135 using compatible computing devices 115-130, with network connectivity, via the communications network 100. Such users may include brokers, bankers, counselors, borrowers, lenders, closing agents, government personnel, system administrators and others. By way of example and not limitation, such end-user computing devices 115-130 may include personal computers, laptop computers, handheld computers, personal digital assistants, smart phones or any similarly equipped electronic computing devices. The system is scalable. Although four user computers 115-130 are shown for illustrative purposes, any number of user computers may be used in accordance with the invention. Each user computer 115-130 includes an operating system and a user interface, such as a web browser, configured to interact with the server 135, process data sent by the server 135, and transmit data to the server 135 in a manner suitable for processing. Additionally, various forms of network connectivity may be used by the user computers 115-130 to access the server 135.

Optionally, a government computer server 105 with data storage 110 may be accessible. The government server 105 may used for recording documents, such as certificates of compliance, mortgages and deeds. The government server may be publicly accessible or accessible only through authorized government personnel.

Those skilled in the art will appreciate that a system according to the invention can utilize many different types of communications networks 100. For example, a proprietary Wide Area Network (WAN) or a public WAN such as the Internet may be used. These networks typically employ various protocols such as the HyperText Transfer Protocol (HTTP), Extensible Markup Language (XML), and Transfer Control Protocol/Internet Protocol (TCP/IP) to communicate information between remote computer systems. A system according to the present invention may also utilize wireless networks, including wide-area cellular telephone networks (e.g., 3G) as well as those utilizing Global System for Mobile (GSM), Code Division Multiple Access (CDMA) or Time Division Multiple Access technology, and the Wireless Application Protocol (WAP). A system according to the invention may utilize any or any combination of, such communications networks and new network technologies hereafter developed.

A firewall may be located between each server 105, 135, and the network 100 to protect against corruption, loss, or misuse of data. The firewall limits access by the user computers 115-130 and prevents corruption of data. Thus, the user computers 115-130 may access and receive only data that is deemed necessary and authorized according to firewall settings. The firewall may be integrated within the servers 105, 135 as software, firmware or a hardware component, or constitute another system component, or reside as a standalone component.

The processes, functions and/or algorithms described herein are implemented in hardware, firmware, software or a combination of software, firmware and hardware. The software comprises computer executable instructions encoded in a computer readable media. Further, such functions correspond to modules, which are software, hardware, firmware, or any combination thereof. Multiple functions are performed in one or more modules as desired, and the embodiments described are merely examples. The software is executed on a digital signal processor, application-specific integrated circuit, microprocessor, or other type of processor operating on a system, such as a personal computer, server, a router, or other device capable of processing data including network interconnection devices. Some embodiments may implement the functions in two or more specific interconnected hardware modules or devices with related control and data signals communicated between and through the modules, or as portions of an application-specific integrated circuit. Thus, the exemplary process flow is applicable to software, firmware, and hardware implementations.

The databases 110, 140 contain a comprehensive collection of user and loan data as well as other relevant data arranged, organized, indexed and/or retrievable based on name, address, social security number, property identification number and/or other identifying criteria. The system database 140 comprises loan data obtained from users input for each transaction; and user (i.e., lender, borrower, counselor, and broker) data obtained during registration and use of the system. Each item of data acquired and entered into a database 140 is associated with a particular address, geographical region, user, transaction, session or other identifier. When a report is requested as discussed herein, available records indexed by the same address, geographical region, user, transaction, session or other identifier are selected.

A single system database 110, 140 is shown for each server for reference convenience. While the database is conceptually illustrated as a single database in the Figures, those skilled in the art will appreciate that the database 110, 140 may be subdivided into component databases. Thus, one or more databases may be used with each server 105, 135. The invention is not limited to any particular data, database structure or data model.

The databases 110, 140 may be any conventional database capable of effectively storing collections of records in an organized accessible manner to permit efficient easy access to desired pieces of data, i.e. one or more records, for example, associated with a particular property, using appropriate database management system software. The data may be obtained and updated online or off-line, in real-time or in batch mode.

A user interface allows users to interact with system in a conventional manner. The user interface, such as a graphical user interface (GUI) which may be a web interface, accepts input via devices such as a computer keyboard and pointer (e.g., mouse) and provides output on the computer monitor display. In a web-based implementation, the user interface accepts input and provides output by generating web pages which are transmitted via the Internet and viewed by the user using a web browser program. Such implementations may utilize Java, AJAX, Adobe Flex, Microsoft .NET, or similar technologies to provide real time control in a separate program, eliminating the need to refresh an HTML based web browser. Available commands may be compiled together in menus and activated through a pointing device or keyboard input.

Referring now to FIG. 2, a high level flowchart of steps of an exemplary lending management and compliance process for brokers according to principles of the invention is conceptually shown. The broker (i.e., mortgage broker) acts as an intermediary who sells mortgage loans on behalf of lenders. Banks and other lending institutions sell their own loan products using their own personnel. However, as markets for mortgages have become more competitive, most lending institutions have also utilized brokers to outsource the job of finding and qualifying borrowers. During the process of loan origination, the broker gathers and processes paperwork associated with mortgaging real estate. Those skilled in the art will appreciate that the role of the broker may be performed directly by a representative of a lending institution. Therefore, as used herein, the term broker is intended to encompass any person who handles a mortgage loan application on behalf of a lender.

When a broker/loan originator has obtained a mortgage loan application from a borrower, as in step 200, the broker/loan originator is ready to use the system. Optionally, the system may require use within a determined number of days (e.g., within 10 days) of receiving the application, to ensure that the application information is current.

Access to the system is limited to registered users, as in step 205. Registered users may be assigned a user name and password to login. If a user has previously registered, the user may login in step 215. A previously unregistered user must proceed through a registration process, as in step 210, before logging in. The registration process entails receiving user information (e.g., name, principal address, contact information). Other information (e.g., billing information for a fee based system, license information for licensed users, etc. . . . ) may also be required. The system then creates an account for the user. The account information is stored in a database, such as database 140, as part of the registration step 210.

Online login tools may be provided to allow users password protected access to the system, for purposes of updating their account information and using the system to process transactions. Thus, the system stores user information, which can be associated with each transaction.

For each session, a record is created, as in step 220. The login may be used for session tracking. All communicated data (e.g., responses to requests) are stored on a server (e.g., in a database) and associated with an identifier for the user and the session. The identifier may also be used for security, as well as change and access logging. Thus, the system may limit access to certain attributes to approved users and groups. Additionally, the system may keep records of access occurrences and changes associated with a user and session, thus creating an audit history.

For illustrative purposes, the exemplary system and process may require counseling under certain circumstances. However, the invention is not limited to systems or methods that may require counseling. If counseling is required under certain circumstances, a determination is made if the transaction is exempt from the counseling requirement, as in step 225. The system may be configured to require counseling for some or all transactions, as determined according to certain criteria. By way of example and not limitation, a transaction may be exempt if (a) it does not involve residential real estate or (b) it involves residential real estate but is a conforming loan, according to prevailing Federal National Mortgage Association (Fannie Mae) and Federal Home Loan Mortgage Corporation (Freddie Mac) guidelines and does not include: (1) an adjustable rate during the first three years of the loan, (2) interest-only payments (on a closed-end loan), (3) negative amortization, (4) a prepayment penalty, or (5) points and fees that exceed a determined amount (e.g., five percent). Illustratively, transactions for commercial property and multifamily residential housing (e.g., housing comprising more than 4 units) may be exempt. If the transaction is exempt, control is passed to step 260, where an exemption certificate is printed for recordation with the mortgage papers in step 265.

In an exemplary implementation, counseling may be required, as in step 230, for certain loans. By way of example and not limitation, counseling may be required for any subprime loan and for any loan with certain risk-related characteristics, regardless of whether or not the loan qualifies as a subprime loan.

While the definition of subprime loan may vary, broadly defined it is a loan provided to a borrower having a heightened perceived risk of default, such as those who have a history of loan delinquency or default, those with a recorded bankruptcy, or those with limited debt experience. In an exemplary implementation a subprime loan is a loan where any one of the following exists: (a) the borrower has a credit score below a particular level, e.g. a FICO score below about 680 to 600, preferably 620; (b) the borrower has a debt-to-income ratio greater than about 40% to 50%, preferably 45%; (c) there is a combined loan-to-value ratio greater than a predetermined limit, e.g., about 85% to 95%, preferably 90% (meaning that the borrower is paying less than a 10% down payment); (d) the loan amount exceeds the conforming loan limit established by an underwriter, quasi-governmental or governmental entity (e.g., the limit of $417,000 for 2009 for single family residences for most areas in the U.S. established by the Office of Federal Housing Enterprise Oversight (OFHEO)); (e) the borrower is unable or fails to provide full documentation of income and assets.

Various documents may be required for verification of income and assets. By way of example and not limitation, such documents may include W-2 statements, federal tax returns, a credit report (or authorization to obtain a credit report), a Uniform Residential Loan Application (Fannie Mae Form 1003), a Uniform Residential Appraisal Report (Fannie Mae Form 1004), a Verification of Employment (Fannie Mae Form 1005), a Verification of Deposit (Fannie Mae Form 1006), a Single Family Comparable Rent Schedule (Fannie Mae Form 1007), a Transmittal Summary (Fannie Mae Form 1008), a copy of the deed of the borrower's current home, federal income tax records, a Verification of Mortgage (VOM) or Verification of Payment (VOP), a Borrower's Authorization, a Purchase Sales Agreement, a Self-Employed Income Analysis (Fannie Mae Forms 1084A and 1084B), and a Comparative Income Analysis (Fannie Mae Form 1088)-used if borrower is self-employed.

To determine whether a transaction is exempt under step 225 and whether counseling is required under step 230, information about the loan is input into the system in accordance with step 220. Such information may be input via a user interface, as described above. Implementations that do not require counseling will still require entry of information about the loan from the various participants (e.g., broker, lender, and closing agent) as described herein. The collected information may be analyzed for compliance with legal requirements other than counseling, for indicia of fraud. The collected information may also be compiled in reports and utilized for planning and regulatory purposes. By way of example and not limitation, the system may determine whether a transaction complies with laws that require a borrower to receive a good faith estimate (as required by the Real Estate Settlement Procedures Act), and/or laws that require certain disclosures, and/or laws that limit loans that have rates and fees above specified amounts and prohibit specific acts and practices in connection with mortgage transactions (as provided in The Truth in Lending Act).

The information collected from the broker includes information pertaining to the borrower, property, loan applied for, broker/loan originator, third parties, notices, and sale and leaseback transactions. In loan transactions without a broker, the information may be collected directly from the loan originator, such as a loan officer of a lending officer.

The information pertaining to each borrower may include information available on the Uniform Residential Loan Application, Fannie Mae Form 1003 as well as other information. The system may support one or more (e.g., up to two) borrowers per loan application. By way of example and not limitation the borrower information includes for each borrower a name; e-mail address; present address; social security number, taxpayer identification number or alien identification number; date of birth; income and expense information contained in the mortgage application. The borrower information may also include the borrower's credit score at the time of application. While only one score may be required, several (e.g., 2 or 3 scores) may be entered. The scores may be input under the identifying names, such as Beacon, Empirica, or Fair Isaac Risk Score. Furthermore, the borrower information may contain income information, including whether the income is verified or stated.

The information pertaining to the property includes information used to identify the particular piece of property, its price, use and taxes. By way of example and not limitation the property information includes the address and an identification number (e.g., a parcel number or permanent index number (PIN)) for the property, a description of the property/collateral (e.g., single family or not greater than four units), the purchase price, annual real estate taxes, annual homeowner's association assessments (if applicable), any special assessments and whether other loans are secured by the same property (yes or no).

The information pertaining to the loan for which the borrower has applied includes all loan transaction parameters. By way of example and not limitation the loan information includes the amount of loan or loans being applied for, whether the purchase is by a first time home buyer or a refinance, the note rate, the annual percentage rate, whether the loan is interest only (yes or no), the term of the loan (e.g., number of months), whether the loan carries negative amortization (yes or no), whether the loan has a prepayment penalty (yes or no), whether the interest rate adjusts within a determined initial period of time such as 3 years (yes or no), the monthly payment including taxes and interest, whether the borrower financed the subject property within the 12 months prior to the date of the application (yes or no), the down payment amount, all points and fees, and the points and fee percentage of loan amount.

The information pertaining to the broker and loan originator includes identification and transactional information. By way of example and not limitation the broker/loan originator information includes the name of the loan originator, the loan originator's company license # and business address, the loan originator's registration number and address, all licensee (e.g., broker) fees (e.g., points, yield spread premium, other), how the licensee obtained the client and referral source.

The information pertaining to third parties includes identification and transactional information. By way of example and not limitation the information may include identification of each appraiser, title insurance company, closing agent, attorney, and all other real estate professionals involved in the transaction. In addition a statement of any moneys received from the broker or loan originator in connection with the transaction may be provided for each party.

The information pertaining to notices includes information about required and/or recommended notices. By way of example and not limitation the information may include information pertaining to a good faith estimate, information pertaining to truth in lending notices, and affirmation (yes or no) that all notices required by law have been supplied by the broker to the borrower.

The information pertaining to sale and leaseback includes information about whether or not the transaction is a sale and leaseback. If the transaction is a sale and leaseback, names and related contact information for the lessor and lessee, seller and purchaser are provided.

In sum, the system facilitates collection of all information pertaining to a lending transaction, including, identifying information for the borrower, credit score information for the borrower, income and asset information for the borrower, debt information for the borrower, the type of loan, the loan parameters (e.g., any down payment, the interest rate, the loan to value ratio, whether the interest rate is fixed or variable, if the rate is variable the basis for adjustment, any caps on variable interest, principal, payment amounts and frequency, any balloon payment, the term of the loan, any prepayment restrictions or penalties), the type of property being financed, the address of the property, and the type of documentation provided in support of the loan. The system facilitates collection of such information for all mortgage lending transactions in a jurisdiction, thus providing a central data source for management, monitoring, planning and enforcement by regulatory offices.

Collecting and storing the information serve several purposes. Targeted data collection can help transform the regulatory business for state regulators. By providing key information of all parties (agent, broker, appraiser, etc.) in the end to end process, a regulator can point to potential issue areas with real-time enforcement capabilities. The collected information may be analyzed for indicia of fraud, compiled in reports for regulatory and legal review, utilized for planning purposes and provide a record of each loan transaction and each participant's involvement. Additionally, the information may be updated to reflect foreclosures and mortgage satisfactions, thus providing a record from loan origination to culmination. Requiring participants to enter the information as a prerequisite for completing a loan transaction and recording a mortgage, foreclosure and satisfaction discourages fraud by creating a clear evidentiary record.

As mentioned above, certain characteristics of a subprime loan may compel counseling in jurisdictions that require counseling. Such characteristics, referred as triggers or triggering characteristics, may include features indicative of subprime loan, such as: (1) an adjustable rate without adequate protections against increases in interest rates, (2) interest-only payments (on a closed-end loan), (3) negative amortization (i.e., where the loan payment for any period is less than the interest charged over that period so that the outstanding balance of the loan increases), (4) a prepayment penalty, or (5) points and fees that exceed a determined amount (e.g., five percent). Adequate protection against increases in interest rates include (a) a possible initial period (e.g., three years) with a fixed rate (which gives the borrower a chance to increase his/her annual earnings before payments rise); (b) a maximum (cap) that interest rates can rise in any year; and (c) a maximum (cap) that interest rates can rise over the life of the mortgage. Thus, illustratively, a loan that allows rate increases in the first three years or allows rate increases without any annual or lifetime cap may trigger counseling. Borrowers applying for reverse mortgage financing of residential real estate under programs regulated by the Federal Housing Authority (FHA) that require HUD-certified counseling may be processed using the system.

If counseling is recommended or required under step 230, the borrower may then be allowed to select an approved counseling agency (i.e., an agency approved by a governmental entity, such as the Department of Housing and Urban Development, for mortgage loan counseling) and meet with a counselor regarding the mortgage application. The system may send notification (e.g., by US Mail or electronically) to the borrower that counseling is necessary. General information such as a general awareness brochure with key contact information may be included with the mailing to describe the mortgage loan process. Notification is also given to the broker and loan originator electronically (e.g., by immediate response on screen, e-mail, and/or electronic report delivery). Along with the notification, the system supplies the borrower with a list of approved housing counselors. The broker or originator may pay for all costs related to the counseling. Requiring the broker or originator to pay may discourage loan offers to borrowers who cannot afford the loan.

During counselor review, as in step 235, the counselor reviews the borrower's loan documents, assets, income and debt; assesses whether the borrower can afford the loan; advises the borrower on the loan terms and conditions including payments; and recommends other loan and rental options where appropriate; and reaches conclusions. The counselor may have a determined time period (e.g., 7 or 10 days) to submit a report to the system, once counseling has been required. This quick turnaround helps reduce risks that counseling becomes a bottleneck, or that borrower's financial condition is no longer accurately reflected in the loan documents, or that market conditions change drastically. Loan originators and brokers cannot take any legally binding action until a determination is made that counseling is not required or until a counselor inputs data (i.e., a report corresponding to the counseling session) as in step 240, which is accepted by the system.

Counselors may enter information into the system by logging in and accessing an existing record through a PIN, social security number/alien ID, borrower name or other unique identifier for the record. A counselor may enter information into system through keyboard entry. The information entered by the housing counselor may be the same as the information that the loan originator/broker collected. Such information may include, without limitation, information pertaining to the borrower, property, loan applied for, broker/loan originator, third parties, notices, and sale and leaseback transactions. Each of these categories of information is described in greater detail above. For previously entered information, the counselor may confirm, enter different values, or indicate that the information is unavailable. Based upon the counselor's session with the borrower and review of the information and documents provided by the borrower, the counselor may render an opinion. The opinion may be generated as responses to a series of predetermined statements. A response (e.g., a yes or no response) may be required for each statement. Illustratively, the statements may include: the loan should not be approved due to indicia of fraud; the loan should be approved, no material problems notes; the borrower cannot afford the loan; the borrower does not understand the transaction; the borrower does not understand the costs associated with the transaction; the borrower's monthly income and expenses have been reviewed and disclosed; the rate of the loan is above market rate; the borrower should seek a competitive bid from another broker or originator; there are discrepancies between the borrower's verbal understanding and the originator's completed form; the borrower is precipitously close to not being able to afford the loan; the borrower understands the true cost of debt consolidation and the need for credit card discipline; and the information that the borrower provided the originator has been amended by the originator.

After the counselor has input data regarding the counseling session as in step 240, a closing agent verifies the terms of the loan, as in step 245. The closing agent is usually either an attorney or a representative of a title company. The closing agent handles the closing and legal transfer of title and ownership from the seller to the buyer. The closing agent secures documentation from the lender, including the complete loan package from the entity providing the mortgage. The closing agent obtains closing instructions and details concerning disbursement of the mortgage funds. At the loan closing, the agent ensures all documents are properly signed, witnessed, and photocopied for distribution to the appropriate parties. Following closing, the agent records the deed and mortgage.

Triggers may also be used to alert regulators in any jurisdiction, whether or not the jurisdiction may require counseling under certain circumstances. Transactions having subprime loan characteristics may be flagged for regulator attention. Regulators may be notified of each loan transaction having subprime loan characteristics. Reports may compiled to highlight subprime loans.

Closing agent access may be limited to the information needed to perform business functions. The closing agents may confirm existing information, enter new information, or designate that they do not have access to the information requested. Prior to closing a loan, the closing agent will enter (or verify) all trigger information in the system. Such information is described above. The source documents may be supplied to the closing agent by the lender. The closing agent may mark a loan “Ready to Close” by entering a transaction into the system. The closing agent may make non-material (non-trigger) changes into regarding records for purposes of certificate issuance. The closing agent also provides settlement information required under The Real Estate Settlement Procedures Act, (“RESPA”), 12 U.S.C. §2601-2617, which requires lenders to provide a good faith estimate for all the approximate costs of a particular loan and finally a HUD-1 (for purchase real estate loans) or a HUD-1A (for refinances of real estate loans) at the closing of the real estate loan. The final HUD-1 or HUD-1A itemizes the costs of the loan and to whom the fees are being allotted. Additionally, the closing agent may provide POC fees or payments rendered outside of normal title insurance and underwriting fees due at the time of closing a loan, including any yield spread premium (YSP). YSP is a cash rebate paid to a mortgage broker based on selling an interest rate above the wholesale par rate for which the borrower qualifies. Furthermore, the closing agent inputs names and business addresses of all individuals present at the closing, including any loan originators, brokers, appraisers, sales persons, attorneys, surveyors and other persons as applicable; the date of closing; a list of all notices provided to borrower, including a HUD-1 Settlement Statement, a Notice of Assignment, Sale or Transfer of Servicing Rights, and Escrow Account Disclosure, a Truth in Lending Disclosure Statement, a Good Faith Estimate of Settlement Costs, a First Payment Letter, a High Risk Home Loan Disclosure, a Notice of Right to Rescind, a Notice of Right to Terminate Private Mortgage Insurance, a Rate Lock/Float Agreement, a Changes Affecting Loans in Process, and a Power of Attorney Appointment, as applicable. A Closing Certificate (step 260) will not be issued until this occurs.

If the terms of a loan change after counseling, as determined in step 250, recounseling may be required based upon the new terms, as in step 255. Terms may change due to requirements or corrections of the borrower, lender, or closing agent. The counselor may also prompt changes to the terms. Illustratively, if the loan originator or broker changes any of the following information (i.e., trigger information) after initial counseling, the system may require recounseling: borrower name; prepayment penalty; negative amortization; points and fees in excess of 5% of loan amount; interest only; rate adjustments in 3 years or less; the PIN or social security number, tax identification number, or alien id. Additionally, recounseling may be required if loan terms have been modified to meet a counseling standard or if interest rate on loan has increased by an appreciable amount (e.g., more than 200 basis points). The results of a recounseling decision may be displayed on the input screen. The possible results of re-counseling evaluation, as in step 255, are: no change from initial decision and no notice sent to borrower, counseling was initially required and is no longer required with notice to be sent to borrower by e-mail and/or U.S. Mail, counseling was not initially required and is now required with notice to be sent to borrower by e-mail and/or U.S. Mail. Furthermore, when a loan originator/broker changes trigger information before counseling is required, the system may notify the loan originator/broker through an online screen that changing the information could result in the need for the borrower to attend counseling. If recounseling is required, control passes to the access step 205 to start a new session.

If the terms have not changed, as determined in step 250, then a certificate is generated in step 260. The certificate is a formal declaration documenting that the foregoing steps of the method have been followed and any required conditions (e.g., required counseling) have been satisfied before a subprime loan transaction is finalized. The certificate may be provided in electronic and/or printed hardcopy forms. The closing certificate, which may be provided to the closing agent, includes an execution date, amount of mortgage, grantor, grantee, PIN number, property address, certificate number, reason certificate was issued. The format of the Closing Certificate may be a PDF document and will be printed by the closing agent.

Closing certificates may be generated for all transactions within a jurisdiction, including exempt and non-exempt transactions. Closing certificates may be issued based on several scenarios. Illustratively, in jurisdictions where counseling may be required a certificate may indicate that the borrower is exempt from counseling; the borrower required housing counseling, and housing counseling requirements were met; the lender is exempt; the property is exempt; and the borrower did not require housing counseling, and housing counseling was not provided. As another example, in jurisdictions where counseling is not required, a certificate may indicate that the originator, lender and closing agent represent that all required information has been supplied and is complete and accurate to the best of their knowledge. As yet another example, in jurisdictions where counseling is not required, a certificate may indicate that all required information fields have been completed.

The mortgage and deed for the property are typically recorded in the county where the property is located. Closing certificates will be filed with the county recorder. The certificate is recorded with the mortgage and/or deed in step 165. Recording systems established by state statutes typically provide for an office of a recorder (e.g., Recorder of Deeds) in each county or other jurisdiction. Usually deeds, mortgages (whether or not in the form of deeds of trust) easements, and court orders may be recorded under the statute. There is generally added to these a catch-all category of “other instruments affecting the title to real estate.” The certificate may be recorded under this category or as part of the deed or mortgage. Thus, the closing certificate may be considered part of another document (deed, deed of trust, or mortgage), not a separate document for purposes of accessing filing fees. A jurisdiction adopting a system in accordance with principles of the invention may require a certificate to accompany every mortgage (whether or not in the form of a deed of trust) being recorded.

Advantageously, by providing counseling and encouraging brokers to ensure that borrowers understand their options and can afford their mortgages, the system and methodology protect unsophisticated borrowers and discourages unscrupulous predatory lending. The system and method help ensure that brokers or originators cannot lend to borrowers, including subprime borrowers, without good faith, documented knowledge of their ability to repay and confirmation that the borrower has been advised of terms and options. In so doing, the system and method discourage unscrupulous lending. The system and method also place an additional protective layer on the financial transaction. Not only must the broker or originator have reasonable belief that the borrower can repay, in the case of subprime lending the broker may also have to certify that the borrower has received counseling from an approved counselor. Concomitantly, investors and underwriters dealing with certified subprime mortgages (i.e., mortgages accompanied by a certificate as described above) will have greater assurance that default is, on average, less likely than with uncertified subprime loans. Consequently, the value of certified mortgages in secondary markets is enhanced.

Reporting tools may be provided to allow users to interactively interrogate the database, analyze its data and update it according to the user's privileges on data. The reporting tools may also allow the user to custom-design reports. A report can be previewed on a screen, printed onto paper or exported to one of several different file formats such as, for example, PDF, Microsoft® Excel, text or CSV. Report formats can vary from a simple column of values to layouts featuring pie charts, bar charts, cross-tab summary tables and nested sub-reports.

Thus, for example, government regulators and agency representatives may use the system as a tool to monitor the lending practices of brokers and loan originators. For the first time, reports containing summaries of loan terms, corresponding addresses and counseling outcomes will be made accessible to government officials. This will enable governments to take a more proactive approach in addressing any perceived abuses. This will also enable governments focus outreach on areas targeted by subprime lenders. Some reports from the system may include new loans; new loans with counseling; new loans without counseling; new exempt loans; reports for individuals and/or entities such as borrowers, housing counselors, closing agents, originators, brokers, and lenders; suspect reports (reports for transactions where a problem or irregularity was detected); predatory pricing (reports for transactions where below market rates are detected); fraud (reports for transactions where deception and/or dishonesty was detected); number of loans registered with the system; number of borrowers receiving counseling; number of loans closed; number of loans requiring counseling; number of loans requiring counseling where the mortgage originator changed the loan terms subsequent to counseling. Predefined reports covering other topics and customized reports may also be provided.

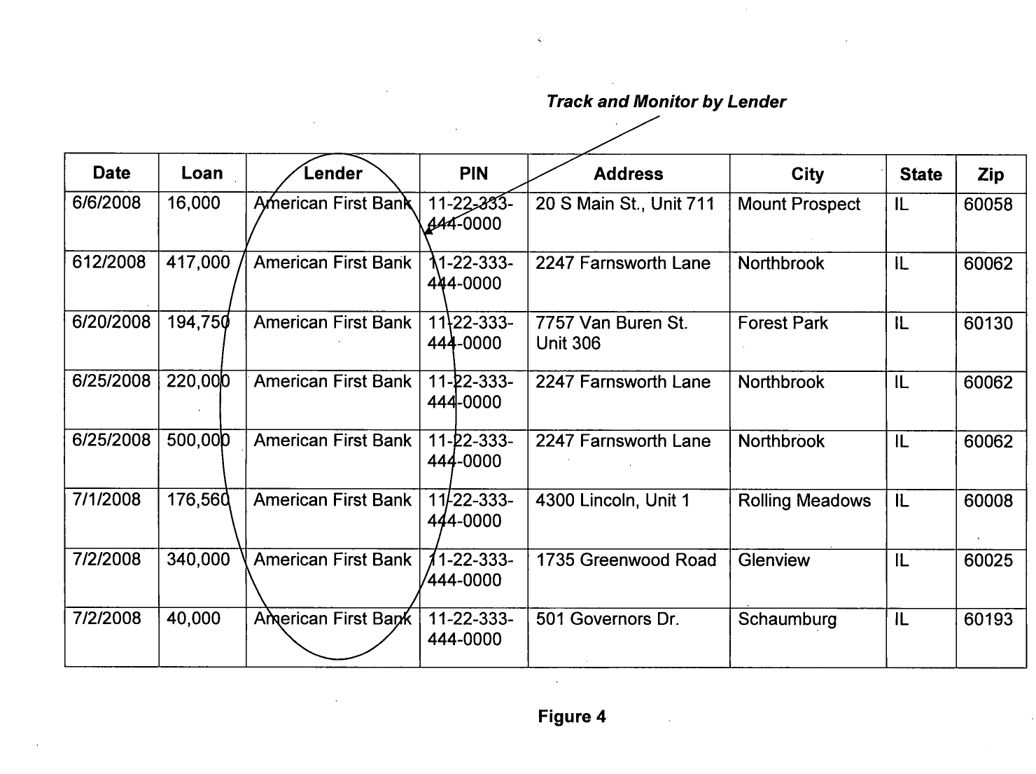

As an example of a report, FIG. 4 illustrates a tabular report sorted by lender. All covered transactions by a particular lender may be identified for tracking, monitoring, examination, analysis and planning by interested parties, such as regulators and other government officials.

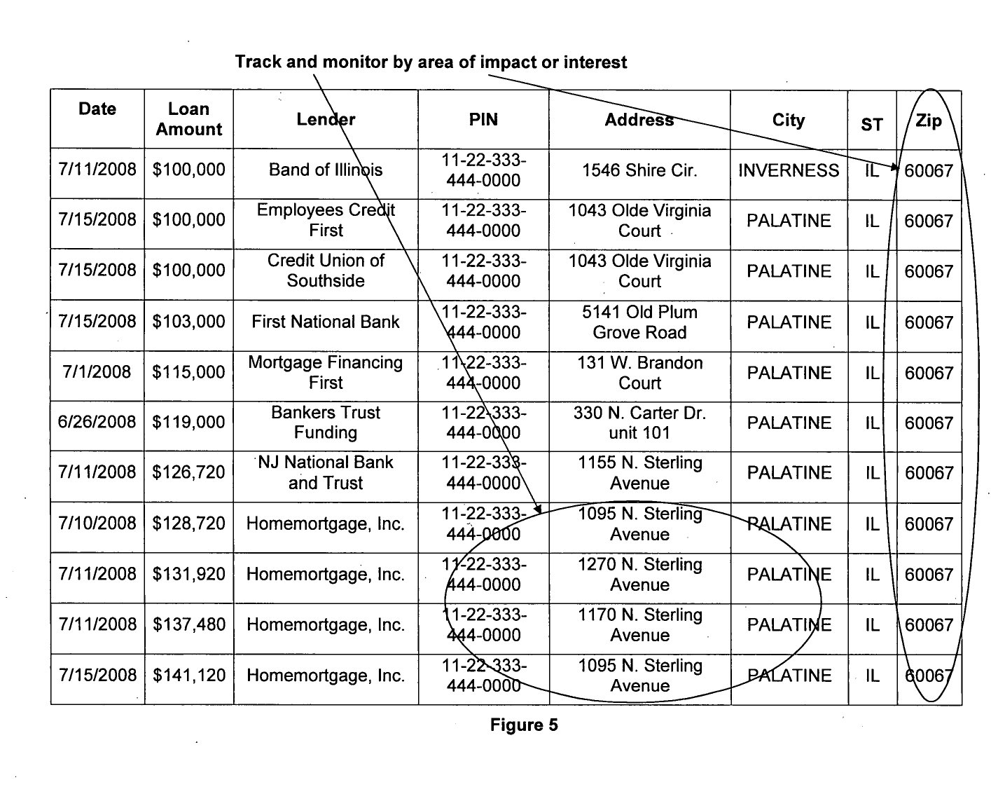

As another example of a report, FIG. 5 illustrates a tabular report sorted by property location. All covered transactions in a particular area, as defined by zip code, address or a range of zip codes or addresses, may be identified for tracking, monitoring, examination, analysis and planning by interested parties, such as regulators and other government officials.

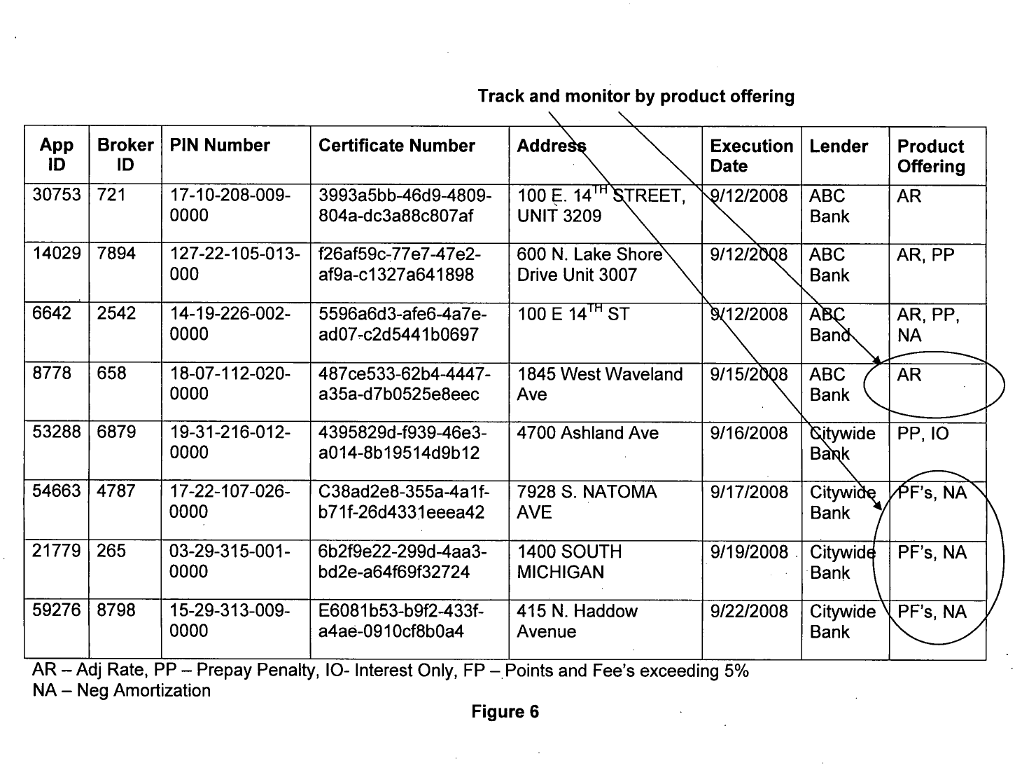

As yet another example of a report, FIG. 6 illustrates a tabular report with a column for loan product description, i.e., loan type or characteristic(s). Each type of mortgage and/or mortgage characteristic may be assigned an identifier such as a code and/or abbreviation. Of particular interest are adjustable rate (AR) mortgages, mortgages with prepayment penalties (PP), interest only (IO) mortgages, mortgages in which points and fees exceed a determined amount such as 5% (PF), and negative amortization (NA) mortgages. Tabular results may be sorted and filtered to identify all loan transactions of a particular type, all loan transactions of a particular type in a particular area, all loan transactions of a particular type by a particular lender and/or originator, etc. . . . Such loans may be identified for tracking, monitoring, examination, analysis and planning by interested parties, such as regulators and other government officials.

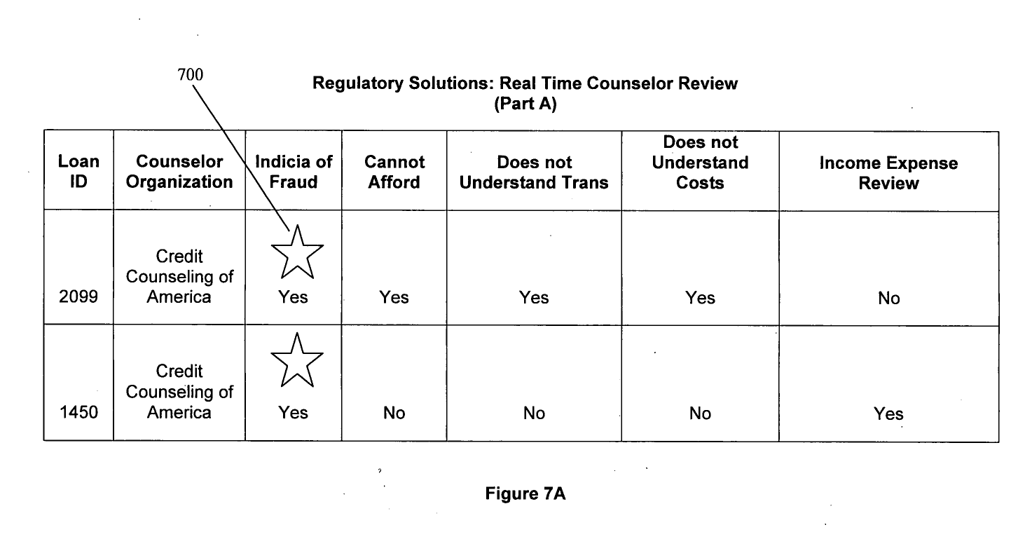

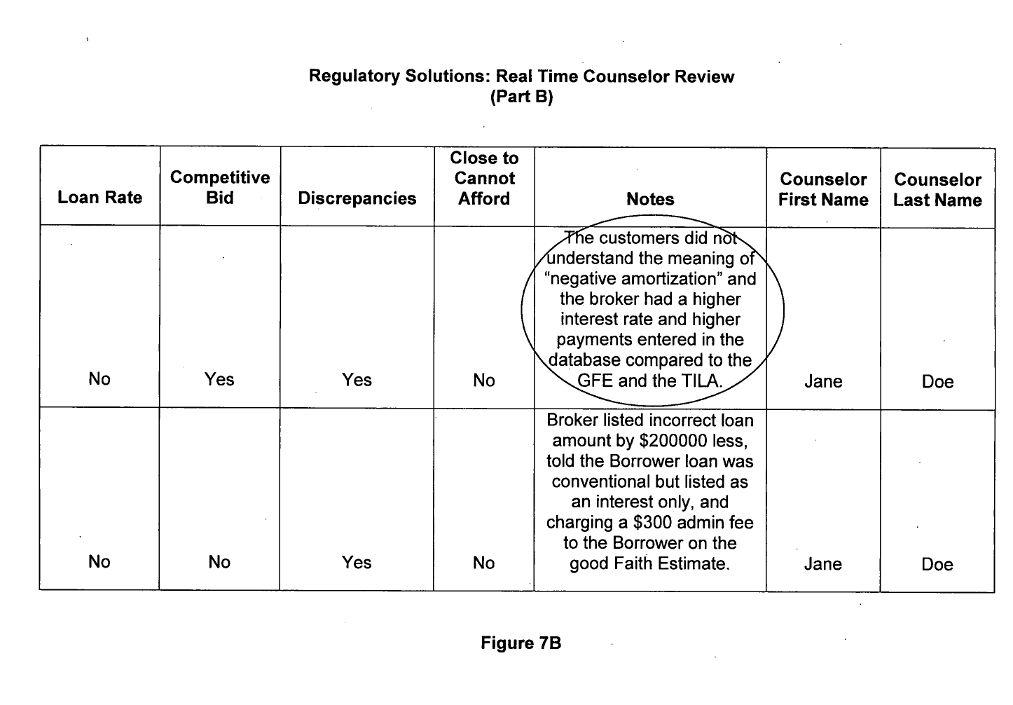

As yet another example of a report, FIG. 7 illustrates a tabular report with certain transactions flagged. The flagged transactions have indicia of fraud. Indicia of fraud may include discrepancies in information entered by various participants (e.g., conflicting information supplied by a broker and closing agent, or by a broker and counselor), and/or discrepancies between information provided on one or more loan documents (e.g., Truth in Lending Act [TILA] disclosure and/or a good faith estimate [GFE]), and/or discrepancies between information provided on one or more loan documents and information separately entered into the system, and/or invalid information (e.g., an invalid social security number), and/or multiple loans for the same property within a defined period of time, or multiple loans for the same borrower within a defined period of time. Heightened scrutiny may apply to adjustable rate (AR) mortgages, mortgages with prepayment penalties (PP), interest only (IO) mortgages, mortgages in which points and fees exceed a determined amount such as 5% (PF), and negative amortization (NA) mortgages. Tabular results may be sorted and filtered to identify all loan transactions with indicia of fraud. Such loans may be identified for tracking, monitoring, examination, analysis and planning by interested parties, such as regulators and other government officials.

Customer service functions, steps and modules may be provided to ensure quality of service delivery for consumers and lenders by providing ready multi-lingual (e.g. English and Spanish) access to information, education, and issue resolution. Preferably highly qualified technical support and help desk support is available to respond within a determined service level to address any issues, monitor the system and provide several levels of support as required to maintain a secure and reliable processing environment. An interactive voice response unit available 24×7 may be provided as an integral part of the call center infrastructure to enables users to access information and conduct business around the clock.

Referring now to FIG. 3, an exemplary computer-implemented software system 300 for lending transaction legal compliance according to principles of the invention includes an account module for creating a user account and managing user access 305; a lending transaction module for receiving lending transaction data for a transaction by the user 310; an analysis module for analyzing lending transactions and determining whether counseling is required 315; a counseling module for determining whether any required counseling for the lending transaction has been provided 320; a recounseling module for determining whether recounseling may be necessary 325; a certificate module for generating certificates of compliance 330; a reporting module 335 for generating tables, charts and summaries of data contained in the system, a flag module 340 for alerting users to determined events, conditions and consequences; and a foreclosure module 345 for associating foreclosure data with properties and parties in the system. The modules 305-345 are associated with a database management system 355 Users interact with the database management system 355 and each of the associated modules 305-345 via an application user interface 350 (such as a web interface). The database management system 355 controls the organization, storage, management, and retrieval of data in the database 140. The database management system 355 accepts requests for data from the application program user interface 350 and transfers the appropriate data in response thereto. The requests may be user generated requests and/or requests generated by one or more modules 305-345. The database management system 355 also receives data entered through the application program user interface 350 operating in combination with one or more modules 305-345 and organizes and stores the data in the database 140.

Each module 305-345 is an identifiable component of the exemplary system 300. Modules 305-345 may stand alone or be combined into a single functional component. One functional component may be configured to perform the functions of one or more modules 305-345, in which case that functional component may serve as each of said modules 305-345. Modules 305-345 may be embodied as hardware, firmware and/or software, including applications, scripts, macros, applets, subprograms, routines, subroutines, procedures, functions, or any computer executable instruction set or portion of code within a larger program, which performs the tasks assigned to the module 305-345.

The account module 305 works with the user interface 350 to enable registration and login according to the steps described above. The module may require new users to input identifying information in order to register. The module may assign or allow a user to select a user name and password. The module may provide account management tools to allow a user to update account information. The module limits access to users with a user name and password.

The lending transaction module 310 works with the user interface 350 to request and receive from a user lending transaction data for a loan transaction. Thus the lending transaction module 310 enables user input of loan information according to the steps described above. As described above, the information describes the borrower, lender, loan and property. The information may be input according to established standards, such as, but not limited to, Fannie Mae 1003 file format. The information may be input via a user interface, such as a web interface displayed in a browser, and/or via other means of communicating data, including, but not limited to, secure socket layer file transfer protocol delivery.

The analysis module 315 analyzes lending transaction data and determines whether counseling is required according to the steps described above. The module compares the lending transaction data input by a user with triggers (i.e., transaction characteristics) that compel counseling. If lending transaction data includes a trigger, the module 315 will indicate that counseling is required. If a user, property or transaction is exempt, counseling may not be required. If a user, property and transaction are not exempt, and the transaction data does not include a trigger, counseling may not be required. Optionally, the module may be configured to provide an explanation in the form of a prepared statement articulating a rationale for requiring counseling.

The counseling module 320 works with the user interface 350 to request and receive from a counselor input to determine whether required counseling for the lending transaction has been provided according to the steps described above. After logging in as described above, a user who is a counselor may access the counseling module to input data pertaining to a counseling session. Access to the counseling module is limited to registered counselors, as well as to system administrators and users having system administrator privileges. Thus, borrowers, lenders and brokers will not be able to enter counseling data. The counseling data, which is associated with the counselor, borrower, lender and proposed loan transaction, supplements, affirms and/or contradicts (i.e., corrects) the loan transaction data previously entered by the user, and describes the counselor's conclusions. The data may be input via the user interface 350, such as a web interface displayed in a browser, or via other means of communicating data, including, but not limited to, secure socket layer file transfer protocol delivery.

The recounseling module 325 monitors events such as changes to the loan transaction data that may compel recounseling according to the steps described above. Changes to the loan transaction data after an initial counseling session, including changes to the loan documentation, borrower data, property data, lender data and/or loan parameters may require recounseling if the change may have any material effect on the risk of nonpayment. The recounseling module acts as a backstop or filter, preventing generation of certificate unless all requisite counseling, including any necessary recounseling, has been completed.

The certificate module 330 generates certificates of compliance according to the steps described above. The certificate affirms that counseling is either not required for the transaction or that all necessary counseling has been provided. The certificate module may provide the certificate in electronic and/or printed form.

The reporting module 335 allows users to interactively interrogate the database and generate reports for purposes of analyze data according to the steps described above. The reporting module prevents unauthorized users from interrogating the database and generating reports. Only certain users, such as governmental officials and system administrators, may have reporting privileges.

The flag module 340 applies rules to flag suspicious activity. The module may provide templates, queries or filters for identifying suspicious activity. Nonlimiting examples include, a borrower having multiple loan applications at a given time or multiple borrowers having activity on the same property in one day. The rules may be predefined, customizable or defined by users with system administrator access.

Optionally, a foreclosure module 345 may be provided to record lis pendens and foreclosures pertaining to any property in the system. A lis pendens is a written notice that a lawsuit has been filed concerning the property, involving either the title to the property or a claimed ownership interest in it. The notice is usually filed in the recorder's office of the county in which the property is located. Recording a lis pendens against a piece of property alerts a potential purchaser or lender that the property's title is in question, which makes the property less attractive to a buyer or lender. After the notice is filed, anyone who nevertheless purchases the land or property described in the notice takes subject to the ultimate decision of the lawsuit. Foreclosure involves the sale of the mortgaged property with the proceeds going first to satisfy the mortgage; then other lien holders; and, finally, the mortgagor/borrower if any proceeds are left. Typically, a deed vesting ownership of the property in a trustee is recorded, again in the recorder's office of the county in which the property is located, as part of the foreclosure process.

Tracking foreclosures and lis pendens enables review of the transactions which ultimately result in default. The characteristics of the transactions (e.g., broker, lender, types of loans, interest rates, variability, and loan to value ratio, etc. . . . ) may be analyzed to identify any patterns. Where appropriate, steps may be taken to reduce risks of default in future similar transactions.

While the invention has been described in terms of various embodiments and implementations, those skilled in the art will recognize that the invention can be practiced with modification within the spirit and scope of the appended claims. The invention is not limited to the exemplary steps and components described above. The selection, arrangement and configuration of components, and the selection and order of steps may be varied within the scope of the invention.

What is claimed is:

1. A computer-implemented method for mortgage lending management and compliance, said method comprising:
creating a user account for each of a plurality of users, said users including at least one loan originator and at least one closing agent;
receiving, from the users, lending transaction data for a loan, property and a borrower;
automatically determining if the loan, as defined by the lending transaction data is complies with legal requirements; and
generating a certificate evidencing receipt of the lending transaction data and compliance with legal requirements.

2. A computer-implemented method for mortgage lending management and compliance according to claim 1, further comprising steps of:
automatically determining if the loan, as defined by the lending transaction data, requires counseling;
if the loan as defined by the lending transaction data requires counseling, transmitting a notice to the borrower indicating that counseling is required; and
receiving, from a counselor, counseling data for the loan and borrower.

3. A computer-implemented method for mortgage lending management and compliance according to claim 1, further comprising a step of determining if a loan, as defined by the lending transaction data, is exempt from counseling.

4. A computer-implemented method for mortgage lending management and compliance according to claim 2, said certificate further evidencing a counseling determination, said counseling determination being a determination from the group consisting of:
counseling was required and provided; and
counseling was not required.

5. A computer-implemented method for mortgage lending management and compliance according to claim 3, further comprising a step of receiving, from a closing agent, verification of the loan, as defined by the lending transaction data.

6. A computer-implemented method for mortgage lending management and compliance according to claim 1, wherein the lending transaction data includes information pertaining to a borrower, property for which a loan is being made, a loan, and a loan originator offering the loan to the borrower.

7. A computer-implemented method for mortgage lending management and compliance according to claim 1, further comprising a step of automatically determining if the loan, as defined by the lending transaction data, is a subprime loan by determining if the loan includes at least one trigger from the group consisting of:
the borrower having a credit score below a determined level;
the borrower having a debt-to-income ratio greater than a determined amount;
a combined loan-to-value ratio greater than a determined amount;
a loan amount exceeding an established conforming loan limit;
omission of documentation from the borrower to support stated income and assets of the borrower.

8. A computer-implemented method for mortgage lending management and compliance according to claim 2, wherein the counseling data includes a counselor conclusion, said conclusion comprising at least one indication from the group consisting of:
the loan should be approved;
the counselor found indicia of fraud;
the borrower cannot afford the loan;
the borrower does not understand the transaction;
the borrower does not understand the costs associated with the transaction;
the borrower's monthly income and expenses have been reviewed and disclosed;
the rate of the loan is above market rate;
the borrower should seek a competitive bid from another source;
there are discrepancies between the borrower's verbal understanding of the loan and the lending transaction data;
the borrower is close to not being able to afford the loan; and
the borrower understands the true cost of debt consolidation and need for credit card discipline; and
the information that the borrower provided the user has been amended by the user.

9. A computer-implemented method for mortgage lending management and compliance according to claim 8, further comprising steps of
determining if lending transaction data for the loan and the borrower has changed after completing the step of automatically determining if the loan, as defined by the lending transaction data, requires counseling, and after said counseling is provided; and
if lending transaction data for the loan and the borrower has changed after completing the step of automatically determining if the loan, as defined by the lending transaction data, requires counseling, and after said counseling is provided, then automatically determining if the loan, as defined by the lending transaction data as changed, requires recounseling.

10. A computer-implemented method for mortgage lending management and compliance according to claim 9, further comprising steps of
determining if lending transaction data for the loan and the borrower has changed after completing the step of automatically determining if the loan, as defined by the lending transaction data, requires counseling; and
if lending transaction data for the loan and the borrower has changed after completing the step of automatically determining if the loan, as defined by the lending transaction data, requires counseling, then automatically determining if the loan, as defined by the lending transaction data as changed, requires counseling.

11. A computer-implemented method for mortgage lending management and compliance according to claim 10, wherein the step of automatically determining if the loan, as defined by the lending transaction data as changed, requires counseling includes determining if the loan, as defined by the lending transaction data as changed, includes at least one trigger from the group consisting of:
the borrower having a credit score below a determined level;
the borrower having a debt-to-income ratio greater than a determined amount;
a combined loan-to-value ratio greater than a determined amount;
a loan amount exceeding an established conforming loan limit;
omission of documentation from the borrower to support stated income and assets of the borrower.

12. A computer-implemented method for mortgage lending management and compliance according to claim 1, further comprising a step of transmitting the certificate to an office of a recorder for a jurisdiction in which the property is located.

13. A computer-implemented method for mortgage lending management and compliance according to claim 1, further comprising a step of flagging a determined transaction before the step of generating a certificate, said step of flagging a determined transaction comprising steps of determining if the lending transaction data includes at least one indicia of fraud and notifying an administrator of the determination.

14. A computer-implemented system for mortgage lending management and compliance, said system comprising a networked computer system including a database functionally coupled to a database management system, a user interface functionally coupled to the database management system, and a plurality of modules operably coupled to the database management system and the user interface, said plurality of modules including:
an account module configured to create a user account and manage user access;
a lending transaction module configured to receive lending transaction data for a transaction by the user, said lending transaction data being entered through said user interface and organized and stored in the database by the database management system;
an analysis module configured to automatically determining if the loan, as defined by the lending transaction data, complies with legal requirements; and
a certificate module configured to generate a certificate evidencing receipt of the lending transaction data and compliance with legal requirements.

15. A computer-implemented system for mortgage lending management and compliance according to claim 14, said plurality of modules further comprising
counseling module configured to automatically determining if the loan, as defined by the lending transaction data, requires counseling, and if it is determined that the loan as defined by the lending transaction data does require counseling, transmitting a notice to a borrower indicating that counseling is required, and receiving, from a counselor, counseling data for the loan and borrower.

16. A computer-implemented system for mortgage lending management and compliance according to claim 15, said plurality of modules further comprising a recounseling module configured to determine if the lending transaction data has changed after counseling and if recounseling is necessary based upon the changed lending transaction data.

17. A computer-implemented system for mortgage lending management and compliance according to claim 16, said plurality of modules further comprising a reporting module configured to generate user selectable reports comprising data from the database.

18. A computer-implemented system for mortgage lending management and compliance according to claim 17, said plurality of modules further comprising a flag module configured to generate alerts in response to determined lending transaction data and counselor data.

19. A computer-implemented system for mortgage lending management and compliance according to claim 18, said plurality of modules further comprising a foreclosure module configured to associate foreclosure data with lending transaction data.

20. A computer-implemented system for mortgage lending management and compliance according to claim 18, wherein the analysis module is configured to analyze the lending transaction data and determine whether the loan, as defined by the lending transaction data, is a subprime loan, by determining if the lending transaction data includes at least one trigger from the group consisting of:
a borrower having a credit score below a determined level;
the borrower having a debt-to-income ratio greater than a determined amount;
a combined loan-to-value ratio greater than a determined amount;
a loan amount exceeding an established conforming loan limit;
omission of documentation from the borrower to support stated income and assets of the borrower.
